(19) United States
(12) Patent Application Publication
(10) Pub. No.: US 2026/0056316 A1
(43) Pub. Date: Feb. 26, 2026

(54) OPTICAL PROXIMITY SENSOR

(71) Applicant: ams International AG, Jona (CH)

(72) Inventors: Veeresh Babu VULLIGADDALA, Hyderabad (IN); Vasanth YADAGIRI, Frisco, TX (US); Gowri Krishna Kanth AVALUR, Hyderabad (IN); Louis Albert WILLIAMS, III, Plano, TX (US)

(21) Appl. No.: 19/117,131

(22) PCT Filed: Sep. 29, 2023
(86) PCT No.: PCT/EP2023/077129

§ 371 Date: Mar. 31, 2025

Related U.S. Application Data
(60) Provisional application No. 63/411,141, filed on Sep. 29, 2022.

(51) Int. Cl. G01S 17/10; G01B 11/02; G01S 7/4861; G01S 7/497

(52) U.S. Cl. CPC G01S 17/10; G01B 11/026; G01S 7/4861; G01S 7/497

(57) ABSTRACT

An optical proximity sensor includes an infrared light emitter, a light detector, and an integrator circuit. The infrared light emitter is configured to emit AC pulses of infrared light, and emit no or low levels of infrared light in-between AC pulses. The light detector is configured to detect ambient light DC signals and infrared light AC pulses emitted by the light emitter and reflected from an object to be detected towards the light detector. The integrator circuit performs a proximity measurement employing the light emitter and the light detector. The integrator circuit includes an ambient light measurement circuit configured to perform an ambient light measurement before performing a proximity measurement and to configure measurement settings of the light emitter and/or the light detector and/or the integrator circuit based on the ambient light measurement. The integrator circuit is configured to perform the proximity measurement based on the measurement settings.

### TECHNICAL FIELD OF THE DISCLOSURE

The field of invention is related to proximity sensing which as an example uses an IR emitter (typically a LED or VCSEL), a receiver (Photodiode), an analog front end (AFE), an ADC and digital processing circuitry. The invention more specifically relates to an optical proximity sensor comprising an infrared light emitter configured to emit AC pulses of infrared light, the infrared light emitter further being configured to emit no or low levels of infrared light in-between AC pulses, further comprising a light detector configured to detect ambient light DC signals and infrared light AC pulses emitted by the light emitter and reflected from an object to be detected towards the light detector, and further comprising an integrator circuit which performs a proximity measurement employing said light emitter and said light detector.

### BACKGROUND

Proximity sensors according to the known art comprise at least two key blocks. One of them conducts ambient light subtraction that is done in the analog domain by a dedicated block, typically a current DAC that estimates the ambient light before the start of every proximity measurement and subtracts it during the proximity measurement process. Another key block comprises a voltage DAC used for crosstalk (CT) compensation. The crosstalk also is estimated prior to proximity measurement and an equivalent DAC code is stored in the digital section.

The residual ambient light (after the above-mentioned subtraction) is cancelled by the proximity circuit itself during the measurement cycle. For removing the residual ambient light and crosstalk compensation, the proximity measurement is done in two phases—one with IR emitter OFF to measure the ambient light (A), and the second with the IR emitter ON to measure the reflected signal (due to emitter ON)+Ambient light (S+A). The effective proximity signal is calculated as P=(S+A)−(A). During this two-phase process, the CT DAC code is applied to perform crosstalk compensation and generate an effective proximity signal (P′) which is ambient light subtracted and crosstalk compensated. This signal is amplified using a switched cap circuit and two amplifiers—first stage and second stage. Finally, the amplified voltage is given to an ADC for digital version.

The main disadvantages of the conventional proximity sensors described above are essentially as follows. They require an ambient current subtraction digital analog converter (DAC). The DAC contributes to the shot noise. The first stage and second stage amplifies this shot noise by their respective gains. Furthermore, a single setting of IR emitter power and receiver is used for all light zones. The setting generally has a high IR emitter power to meet the proximity performance requirements for the brightest light condition. This is not optimal for Behind OLED applications as higher emitter power causes visible screen distortion in low light conditions.

Moreover, in low light condition, which is the majority of device's mission profile time, it unnecessarily overdrives the IR emitter leading to higher average power consumption.

The document U.S. Pat. No. 9,608,132 B2 discloses an optical sensor arrangement and a method for generating an analog output signal.

The document US 2014/0252212 A1 describes a signal conditioning circuit for a light sensor, a sensor arrangement and a method for signal conditioning for a light sensor.

The document U.S. Pat. No. 8,692,200 B2 discloses an optical proximity sensor with improved dynamic range and sensitivity.

The document EP 3 425 802 A1 describes a proximity sensor with crosstalk compensation which comprises a transmitting circuit to transmit a signal to be reflected at a target and a disturbing object, and a receiving circuit to receive a reflected signal having a useful component and a noise component.

### SUMMARY

The object of the invention is therefore to provide an improved proximity sensor which overcomes the disadvantages of known proximity sensors. Another object of the invention is to provide a corresponding method for conducting proximity measurements.

With respect to the proximity sensor, the object of the invention is solved by a proximity sensor according to claim 1. According to the invention, the integrator circuit comprises an ambient light measurement circuit configured to perform an ambient light measurement before performing a proximity measurement and to configure measurement settings of the light emitter and/or the light detector and/or the integrator circuit based on said ambient light measurement, and whereby the integrator circuit is configured to perform the proximity measurement based on these measurement settings.

Preferred embodiments of the invention are specified in the dependent claims and the description.

The invention is based on the consideration that there is a demand on proximity sensors with low power consumption but high accuracy in the determination of proximity information.

Applicant has found that these demands can be met by a proximity sensor with ambient light detection in which the components are configured depending on the measured ambient light. In this way, an optimized configuration for the proximity measurement can be configured on demand, reducing the power consumption and possible artifacts on a display at the same time. To this end, a high accuracy ambient light measurement mode is included in the overall proximity measurement routine.

Preferably, the integrator circuit is configured to perform proximity measurements in cycles, whereby the ambient light measurement circuit is configured to perform an ambient light measurement at the start of each cycle. In this way, each proximity measurement can be performed under the present or current ambient light conditions, allowing an optimized adaptive measurement. Based on the ambient light, the system adapts emitter power to reduce screen distortion and power consumption.

Advantageously, the measurement settings are configured based on the measured ambient light intensity/level. Based on the ambient light, the system selects the gain, no. of PD sections to obtain the best the SNR (signal to noise ratio).

In a preferred embodiment, a plurality of ambient light intensity ranges or zones is defined, whereby for each intensity range related measurement settings are defined in the integrator circuit, and whereby the integrator circuit is configured to select the related measurement settings based on the intensity range which comprises/encompasses the measured ambient light intensity. In this way, an adaption of the proximity sensor settings can be discretized in several discrete settings which can be selected depending on the measured ambient light intensity. The selection of emitter power and receiver settings achieves a reduced/no screen distortion, power consumption and optimum SNR.

Preferably multiple zones are defined based on the total current of the light detector, which is especially built as photo diode (PD), which is a function of ambient light, cross talk and dark current. Each zone has independent software programmable settings to configure the emitter power and receiver circuit parameters.

Preferably, between 3 and 10, especially 5 intensity ranges are defined.

Advantageously, as a measurement setting, the power of the light emitter during the proximity measurement is set dependent on the ambient light intensity.

Preferably, as at least one measurement setting at least one parameter of the light detector is set dependent on the ambient light intensity, especially the number of the PD (photo diode) sections. Dependent on the measured ambient light intensity, the sensitivity of captured light can be attenuated or increased by choosing the number of PD sections. Other parameters are the electrical gain and/or the integration time.

Advantageously, as a measurement setting the amplification/gain factor of the integrator circuit is set dependent on the ambient light intensity.

In a preferred embodiment, the integrator circuit comprises an operational amplifier and a capacitor arrangement with a plurality of capacitors that can be arranged electrically parallel to the operational amplifier, whereby the integrator circuit is configured to select a parallel capacitor of the capacitor arrangement depending on said measured ambient light intensity during the proximity measurement. The capacitor arrangement preferably comprises a number of capacitors which is at least as large as the number of ambient light intensity ranges. Depending on the measured ambient light intensity, the capacitor corresponding to the range which comprises this measured value can be chosen parallel to the operational amplifier.

The ambient light measurement circuit is, preferably essentially, identical to the integrator circuit. The proximity sensor measures the ambient IR light level with no additional circuitry before every proximity measurement and based on the total photodiode (PD) current automatically configures the optimum settings for the proximity sensor

In a preferred embodiment, the proximity sensor comprises a crosstalk measurement circuit, which is preferably implemented in a digital core. The crosstalk measurement circuit is designed to measure the infrared light stemming from the light emitter by the light detector in a no-target condition, i.e., with no object near the proximity sensor.

The no-target condition is determined by the application and not by the device. To this end, the application/user triggers a crosstalk measurement by software command. As an example, the smartphone can lie flat on a surface, and no call is ongoing. No acceleration is measured. Depending on various sensor data, the no-target-condition can be detected. When a call is incoming, the no-target-condition can be ended.

The optical proximity sensor preferably comprises an ADC, whereby the outputs of the measured ambient light and the crosstalk measurements are converted to digital signals in said ADC, and whereby a digital core is configured to conduct ambient light and cross talk corrections of the digitized proximity measurement signal. Ambient, proximity and crosstalk signals are only digitized by the ADC. The crosstalk corrections and further processing is conducted by a digital core which for example is built as a microcontroller/CPU/digital circuit. The crosstalk compensation is performed in this digital core. It is a straightforward arithmetic where the stored CT PDATA is subtracted from the PDATA. The CT compensated PDATA is output for further processing.

Preferably, in the digital core, crosstalk calibration coefficients are stored which are applied during crosstalk correction based on the measured crosstalk signal This allows an adaptive switching of crosstalk compensation value based on normalized no-target output data.

The optical proximity sensor advantageously is configured to provide normalized proximity data as an output. The final proximity data is advantageously normalized based on the selected configuration setting to generate a consistent proximity response across all ambient light zones for a target distance. The normalized proximity data based on the selected emitter and receiver configuration settings is thereby used to generate a consistent proximity response for total light detector/PD current which includes all ambient light zones. In this way, a very reliable and robust output signal is generated which, for instance, can be used by the control unit of a smartphone to switch the display on or off.

In a preferred embodiment, the light detector is built as a photo diode. The intensity or added intensities of ambient light, reflected light and crosstalk light lead to a certain current of the photo diode which can be processed further. The Adaptive switching of emitter power and receiver parameters based on total photodiode (PD) current, which is a function of ambient light, crosstalk and dark current of PD in a proximity sensing application.

Preferably, the light emitter is built as an LED or VCSEL. A light emitter built as an LED is less expensive compared to VCSEL. However, LED's Field of Incidence (FOI) is wider compared to VCSEL which consequently creates unwanted crosstalk. An LED requires much higher current to provide same optical power as a VCSEL. In most of the applications VCSELS are preferred over LEDs.

With the respect to the method, the object is solved with the steps of
in an integrator circuit conducting a proximity measurement by emitting AC infrared radiation by an infrared emitter and measuring the reflected radiation by a light detector;
conducting an ambient light measurement, whereby
   the ambient light measurement is conducted before the proximity measurement, and whereby the infrared emitter and/or the light detector and/or the integrator circuit are configured for the proximity measurement based on the ambient light measurement, especially based on the ambient light intensity.

Preferably, a plurality of ambient light intensity ranges is defined, whereby for each intensity range related measurement settings are defined in said integrator circuit, and whereby the measurement settings are selected based on the intensity range which comprises/encompasses the measured ambient light intensity.

The advantages of the invention are especially as follows. The adaptive switching of the IR emitter power reduces the distortion on the display caused by the IR radiation. Especially on OLED displays lit areas by IR radiation leads to black dots which are visible to the user. Via the ambient light detection and the adjustment of the sensor according to this measurement, a proximity response with optimum power for each light condition is generated, avoiding wastage of excess power in low light conditions, thus reducing average power.

The noise in the analog frontend is reduced by eliminating “analog ambient light detection” and “crosstalk correction” circuits, as these routines are conducted in the digital domain. The digital implementation of ambient and crosstalk cancellation improves the accuracy and resolution. The proximity sensor comprises a low noise analog frontend by eliminating “analog ambient light detection” and “crosstalk correction” analog circuits.

Digital implementation of ambient and crosstalk cancellation improves the accuracy and resolution. As the ambient light subtraction and the crosstalk compensation are fully conducted in the digital domain, the need for an analog circuit for performing those two operations is eliminated and consequently noise is reduced. The final ambient and crosstalk compensated proximity digital data is normalized based on the selected emitter and receiver configuration settings to generate a consistent proximity response across all ambient light zones for a target distance.

With the described differential circuit arrangement approach, a very accurate proximity sensor is realized. It helps to provide an absolutely no-distortion intensity based behind OLED proximity detect solution. Normalized proximity data with consistent resolution is provided across all the device configuration settings.

The described proximity sensor, can, for example, be employed as a BOLED proximity sensor or a large air gap Proximity sensor.

### BRIEF DESCRIPTION OF THE PREFERRED EMBODIMENTS

A preferred embodiment of the invention is discussed in conjunction with a schematic drawing. In this drawing,

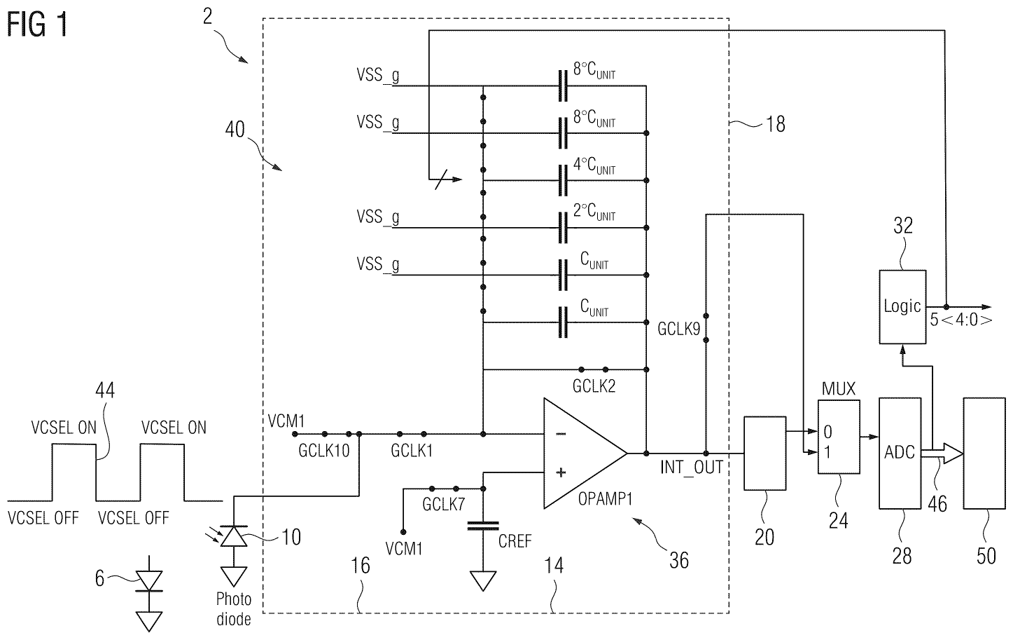

FIG. 1 shows an optical proximity sensor in a preferred embodiment;

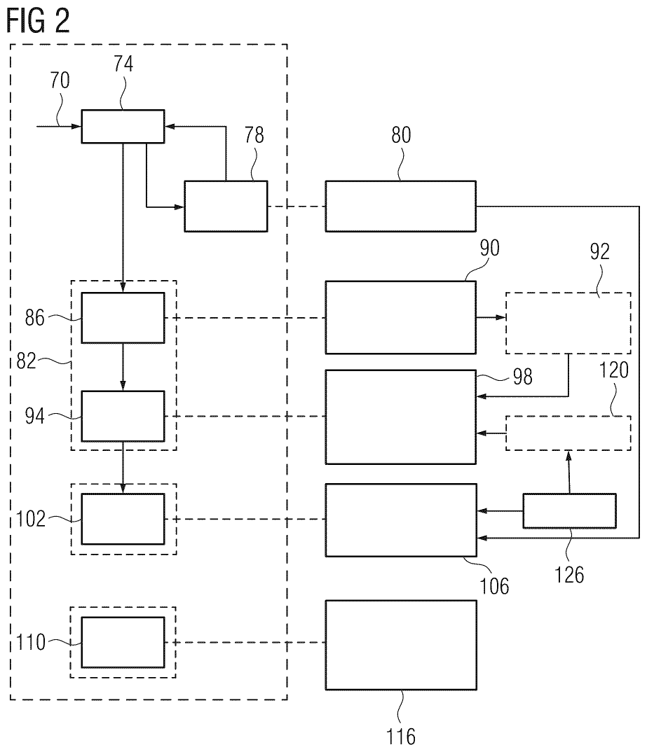

FIG. 2 a flow-chart of proximity measurement scheme in a preferred embodiment, and

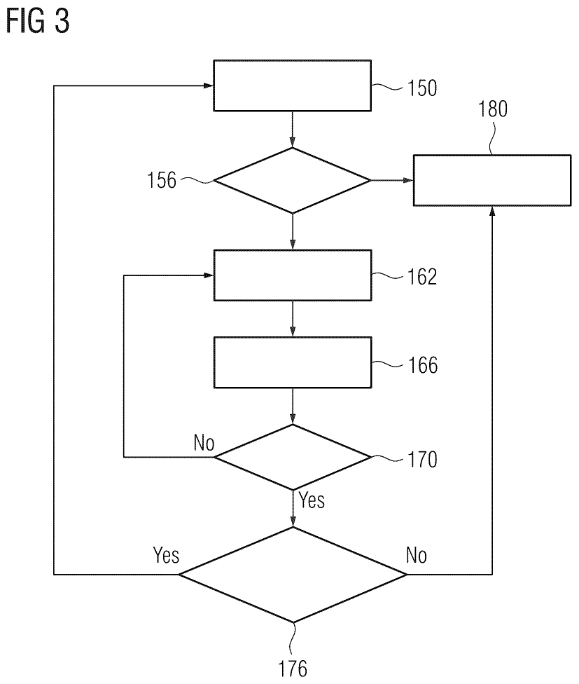

FIG. 3. a flow-chart for ambient light detection.

Identical components are labelled with the same reference numerals.

### DETAILED DESCRIPTION OF THE PREFERRED EMBODIMENTS

The proximity sensor 2 shown schematically in FIG. 1 comprises a light emitter 6 built as a VCEL which emits light in the infrared range and a light detector 10 which is built as a photo diode (PD). The proximity sensor 2 further comprises an integrator circuit 14, a unit 20, a multiplexer 24, an ADC (analog digital converter) 28 and a logic unit 32.

The block or unit 20 shown in FIG. 1. performs three functions
1) Subtract residual ambient component during the Proximity and crosstalk measurement.
2) Amplify the signal from first stage integrator.
3) Accumulate the signal from multiple pulses and hold the signal during ADC conversion.

The block or multiplexer 24 bypasses second stage of the proximity engine during the ambient measurement phase and connects the first stage integrator output to the ADC for digitization.

The integrator circuit 14 comprises an operational amplifier 36 as well as a capacitor arrangement 40 which comprises several, in the present embodiment six, capacitors that can be selected to be connected in parallel to the operational amplifier 36.

The proximity sensor 2 furthermore comprises a light emitter driving circuit (not shown) which drives the light emitter 6 by AC current 44. Light rays emitted by the light emitter 6 are reflected back by an object in proximity to light emitter 6 and are received by the light detector 10, which indicates that the object is close to the proximity sensor 2. When turned on, the light emitter 16 emits AC pulses which are sensed by light detector together with a large Dc contribution of ambient light.

The proximity sensor 2 comprises an ambient light measure circuit 16 which in the preferred embodiment shown is identical to the integrator circuit 14. The integrator circuit 14 comprises a plurality of Global Clock (GCLK) pins. The GCLK pins control the switches in the switched cap circuit.

The analog digital converter or ADC 28 generates a digital output signal 46. This output is connected to a digital core 50. The digital core 50 processes the raw data from the ADC and outputs a normalized proximity data as will be described below. This signal can be used by a control unit/microcontroller of a device, especially a mobile device such a smartphone, for on/off control or dimming of the display while the user or another object is near to the display/proximity sensor.

FIG. 2 shows a flow chart of the proximity measurement. The digital core controls the FSM. All the “Input, Output and Action” activities described below are carried out in the digital core 50.

Referring FIG. 2, the operation of the proximity sensor 2 displayed in FIG. 1 is shown in a flow chart which starts at an arrow 70. The first block is an idle block 74 which is followed by a crosstalk calibration block 78. This block is entered when the application triggers a calibration cycle when it realizes a no-target condition, i.e., no target is detected proximate to the proximity sensor

With no target near to the proximity sensor, the light emitter 6 is driven and the light which reaches the light detector 10 is measured, as is indicated by a block 80. Ambient light is subtracted in block 20 in FIG. 1. Alternatively, it can be conducted in digital core. The measured cross talk light intensity as an output is used for calibration and is stored in the digital core 50 (CT PDATA). When the crosstalk calibration is finished, the method returns to the idle block 74. The crosstalk calibration is preferably triggered by the system software through a command, especially sent from a microcontroller of the device, for instance of a smartphone.

The crosstalk proximity Data (CT PDATA) is thus computed under No Target (NT) condition with screen OFF and is stored for subsequent proximity cycles. The CT PDATA is preferably stored in dedicated registers.

The idle block 74 proceeds to a measurement block 82 in which two measurements are conducted, namely the measurement of ambient light (block 86) which will be discussed in relation with FIG. 3, and the proximity measurement (block 94).

In an ambient measure block 86, the ambient light level/intensity is measured. The measurement of ambient light is performed at the start of every proximity measurement cycle represented by the block 94. Ambient light measurement and proximity measurement are therefore always performed together and subsequently, which is indicated by the encompassing block 82. Based on the measured level of ambient light, an optimum proximity configuration from pre-configured registers is selected, as indicated in a block 90. This configuration comprises measurement settings especially for the light emitter 6, the light detector 10 and the integrator circuit 14. These measurement settings depend on a light zone with a given light level range.

As indicated by a further block 92, based on the detected ambient light level, light zone detection is conducted. Based on the light zone classification (see below for an example), the configuration of light emitter 6 and light detector 10 and integrator circuit 14 is selected, i.e., based on ambient light level, appropriate emitter and receiver settings for the current proximity cycle are selected. The logic unit 32, depending on the light level zone, selects a capacitor of capacitor arrangement 40 to be connected in parallel to the operational amplifier 36.

A preferred light zone classification is shown in the following table. In the left column, several light level labels are given, while the corresponding lux numbers are shown in the right column. The term “AL” indicated ambient light.

| Light Level Zone | Lux |
|---|---|
| HAL (High AL) | 72K to 110K |
| BAL (Bright AL) | 36K to 72K |
| MAL (Moderate AL) | 18K to 36K |
| LAL (Low AL) | 9K to 18K |
| DAL (Dark AL) | 10 to 9K |

Depending on in which interval in the right column the value of the measured light intensity falls, the light level zone in the left column is selected. Each light level zone corresponds to a selection of parameters of light emitter 6, light detector 10 and integrator circuit 14.

Subsequently; in a proximity measure block 94, the proximity measurement is conducted. To this end, the light emitter 6, which in the present preferred embodiment is built as a vertical-cavity surface-emitting laser (VCSEL) is driven and the light emitter 6 is emitting light pulses which are detected by light detector 10 and integrated in the integrator circuit 14.

This integrated signal is then digitized in the ADC 28 and the ADC output is captured in the digital core 50. The resulting output are raw proximity data (Raw PDATA). This is represented by a block 98 The described actions are conducted based on user settings represented by a user settings block 120. The proximity measurement phase is thus conducted with the selected measurement settings and user configured settings. Examples of user Settings are VCSEL drive current, integration time, VCSEL drive pulse length, no. of averages cycles etc.

From block 94, the method continues in a proximity data block 102. In this block, as indicated by a block 106, the proximity data are accumulated and averaged, and the crosstalk compensation is conducted in the digital domain. For the crosstalk compensation, the crosstalk calibration data of block 80 are used.

The actions of blocks 98 and 106 are conducted in relation to 12 configuration registers, as indicated by element 126. The output of these operations are final proximity data which are the averaged proximity data. Finally, the final proximity data (PDATA) are transferred and status flags to read registers at the end of the cycle are set. These status flags are, for instance, ‘new data ready’, ‘data negative’, data zero’, ‘data above or below some threshold’, ‘data saturation (analog and/or digital saturation)’, ‘ambient light saturation’ etc.

The method finishes in an end block 110. As indicated by a block 116, in this end block 110 an assertion of an interrupt is conducted if enabled/an interrupt is generated. The output of block 110 are, if enabled, an interrupt, the final proximity data and status flags. The interrupt behaviour is decided by the application software. Ideally, if proximity data is above a threshold (high data value), then a status bit is set, and an interrupt is generated. The application software reacts to the interrupt by turning OFF the display (as the target (ear) is close to the sensor). Similarly, if the proximity is below another threshold, (Low data value), then another status bit is set, and an interrupt is generated. The application software reacts to the interrupt by turning ON the display (as the target (ear) is far away from the sensor).

In FIG. 3, a method of ambient light measurement which is implemented in the proximity sensor and represented by block 86 in FIG. 2 according to the preferred embodiment is shown as a flow chart.

In a first block 150, an initialization is performed. Initialization includes steps like enabling the reference voltages, preparing the receiver circuit for integration viz., resetting the capacitors in the switch cap circuits.

In a subsequent decision 156, it is decided if an ambient light measurement is conducted or if a proximity measurement should be conducted. It is done automatically in the device and in a sequence controlled by the digital core. The first ambient light measurement is done followed by the proximity measurement.

If an ambient light detection is to be conducted, the method continues in a block 162, in which the proximity sensor 2 is configured for an ambient light measurement, which essentially involves configuring the light emitter 6, the light detector 10, and the integrator 14. After configuration/setup, the ambient light measurement is conducted. The measured ambient light signal is digitized in a block 166, resulting in a digital signal representing the ambient light intensity.

In a decision 170, it is then decided if a prescribed number of ambient light pulses have been measured which allow an averaging of the measured ambient light intensity.

If not enough pulses have been used, the method branches back to block 162, and the ambient light measurement is continued. The term ‘pulse’ here basically indicates the integration time length. The emitter is not enabled in this mode. The purpose of averaging is to reduce noise. As the zone decision and the correct settings for proximity measurement is determined by the ambient light reading averaging is done to reduce noise.

If, on the other hand, all pulses have been emitted, the method branches from decision 170 to decision 176, which branches back to block 150 if the proximity initialization has been conducted and otherwise branches to block 180. There is a provision to repeat the initialization process (step 150) after the ambient light measurement phase. This is a user selectable configuration. If user wants to repeat initialization (for any performance reasons), s/he can enable it through software. It consumes additional time (overhead). If re-initialization the impact on noise is minimal then the user can choose not to do it.

### LIST OF REFERENCE NUMERALS

2 proximity sensor
6 light emitter
10 light detector
14 integrator circuit
16 ambient light measure circuit
18 crosstalk measurement circuit
20 unit
24 multiplexer
28 ADC
32 logic unit
36 operational amplifier
40 capacitor arrangement
44 AC pulses
46 output signal
50 digital core
70 arrow
74 idle block
78 cross talk calibration block
80 block
82 measurement block
86 ambient measure block
90 block
92 block
94 proximity measure block
98 block
102 proximity data processing block
106 block
110 end block
116 block
120 user settings block
126 element
150 block
156 decision
162 block
166 block
170 decision
176 decision
180 block

1. An optical proximity sensor, comprising:
an infrared light emitter configured to emit AC pulses of infrared light, the infrared light emitter further being configured to emit no or low levels of infrared light in-between AC pulses;
a light detector configured to detect ambient light DC signals and infrared light AC pulses emitted by the light emitter and reflected from an object to be detected towards the light detector, and
an integrator circuit which performs a proximity measurement employing said light emitter and said light detector,
wherein
said integrator circuit comprises an ambient light measurement circuit configured to perform an ambient light measurement before performing a proximity measurement and to configure measurement settings of said light emitter and/or said light detector and/or said integrator circuit based on said ambient light measurement, and wherein said integrator circuit is configured to perform said proximity measurement based on said measurement settings.

2. The optical proximity sensor according to claim 1, wherein said integrator circuit is configured to perform proximity measurements in cycles, and whereby said ambient light measurement circuit is configured to perform an ambient light measurement at the begin of each cycle.

3. The optical proximity sensor according to claim 1, whereby said measurement settings are configured based the measured ambient light intensity.

4. The optical proximity sensor according to claim 3, whereby a plurality of ambient light intensity ranges is defined, and whereby for each intensity range related measurement settings are defined in said integrator circuit, and whereby said integrator circuit is configured to select said related measurement settings based on the intensity range which comprises the measured ambient light intensity.

5. The optical proximity sensor according to claim 3, whereby as a measurement setting the power of said light emitter during said proximity measurement is set dependent on the ambient light intensity.

6. The optical proximity sensor according to one of the claim 3, whereby as at least one measurement setting at least one parameter of said light detector is set dependent on the ambient light intensity.

7. The optical proximity sensor according to one of the claim 3, whereby as a measurement setting the amplification factor of said integrator circuit is set dependent on the ambient light intensity.

8. The optical proximity sensor according to claim 7, whereby said integrator circuit comprises an operational amplifier and a capacitor arrangement with a plurality of capacitors that can be arranged electrically parallel to said operational amplifier, and whereby said integrator circuit is configured to select a parallel capacitor of said capacitor arrangement depending on said measured ambient light intensity during said proximity measurement.

9. The optical proximity sensor according to claim 1, whereby said an ambient light measurement circuit is identical to said integrator circuit.

10. The optical proximity sensor according to claim 1, comprising a crosstalk measurement circuit.

11. The optical proximity sensor according to claim 10, comprising an ADC, whereby the outputs of said measured ambient light and said cross talk measurements are converted to digital signals in said ADC, and whereby a digital core is configured to conduct ambient light and cross talk corrections of the digitized proximity measurement signal.

12. The optical proximity sensor according to claim 10, whereby in crosstalk calibration coefficients are stored in a digital core which are applied during crosstalk correction based on the measured crosstalk signal.

13. The optical proximity sensor according to claim 1, which is configured to provide normalized proximity data as an output.

14. The optical proximity sensor according to claim 1, whereby said light detector is built as a photo diode.

15. A method for detecting the proximity of an object, comprising the steps of:
in an integrator circuit conducting a proximity measurement by emitting AC infrared radiation by an infrared emitter and measuring the reflected radiation by a light detector; and
conducting an ambient light measurement,
wherein
said ambient light measurement is conducted before said proximity measurement, and said infrared emitter and/or said light detector and/or said integrator circuit are configured for said proximity measurement based on said ambient light measurement.
